(19) United States
(12) Patent Application Publication
(10) Pub. No.: US 2016/0014620 A1
(43) Pub. Date: Jan. 14, 2016

(54) COOPERATIVE APPLICATION AND NETWORK INSIGHT OPERATIONS IN WIRELESS NETWORKS

(71) Applicant: NOKIA SOLUTIONS AND NETWORKS OY, Espoo (FI)

(72) Inventors: Ram Lakshmi NARAYANAN, Pleasanton, CA (US); Swaminathan ARUNACHALAM, Plano, TX (US)

(21) Appl. No.: 14/794,213

(22) Filed: Jul. 8, 2015

Related U.S. Application Data
(60) Provisional application No. 62/021,926, filed on Jul. 8, 2014.

(51) Int. Cl. H04W 24/02; H04L 1/16; H04W 72/08; H04M 1/725; H04W 24/08

(52) U.S. Cl. CPC H04W 24/02; H04M 1/72522; H04W 24/08; H04W 72/087; H04L 1/1607

(57) ABSTRACT

Systems, methods, apparatuses, and computer program products for cooperative application and network insight operations in wireless networks are provided. One method includes, during application content delivery to a user equipment (UE) associated with a network, monitoring and/or collecting instantaneous radio information from a network node and computing at least cell load and throughput for the network. The method may then include sending the collected radio information, cell load, and throughput information to an application server that is delivering content to the user equipment (UE).

### CROSS REFERENCE TO RELATED APPLICATIONS

This application claims priority to provisional application No. 62/021,926, filed on Jul. 8, 2014. The entire contents of this earlier filed application are hereby incorporated by reference in its entirety.

### BACKGROUND

1. Field

Embodiments generally relate to wireless networks and, in particular, some embodiments relate to improving application services over wireless networks.

2. Description of the Related Art

With the proliferation of wireless smart phones, many people utilize various application services over wireless networks. For example, Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and most of the RNC functionalities are contained in the evolved Node B (eNodeB or eNB).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and multimedia transport in addition to high-capacity voice support. Advantages of LTE include, for example, high throughput, low latency, FDD and TDD support in the same platform, an improved end-user experience, and a simple architecture resulting in low operating costs.

Further releases of 3GPP LTE (e.g., LTE Rel-11, LTE Rel-12, etc.) are targeted towards future international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

Network operators and Application Service providers (ASPs) need to improve performance of networks, application services, and user satisfaction in mobile networks. For instance, video streaming applications (e.g., YouTube™) are very popular and regularly used by mobile network users. However, the user experience for users of application services, such as video streaming applications, is not necessarily satisfactory. Frequent video stalls and buffer under-run, etc. are common user reported problems. Users often blame network operators for such behavior, but operators do not have a way to learn micro-level behavioral changes and user impacts.

### SUMMARY

One embodiment is directed to an apparatus including at least one apparatus and at least one memory including computer program code. The at least one memory and the computer program code are configured, with the at least one processor, to cause the apparatus at least to, during application content delivery to a UE associated with a network, monitor and/or collect instantaneous radio information from a network node and to compute at least cell load and throughput for the network. In an embodiment, the at least one memory and the computer program code are further configured, with the at least one processor, to cause the apparatus at least to send the collected radio information, cell load, and throughput information to the application server that is delivering content to the UE. In an embodiment, the at least one memory and the computer program code are further configured, with the at least one processor, to cause the apparatus at least to receive a UE specific QoE report, to extract the QoE information, and to forward the application traffic to the UE.

In an embodiment, the at least one memory and the computer program code are further configured, with the at least one processor, to cause the apparatus at least to receive a QoE summary report and session summary from the application server, for example upon session termination. In one embodiment, the at least one memory and the computer program code are further configured, with the at least one processor, to cause the apparatus at least to process the QoE summary and session summary to provide additional insight for time series analysis, such as adjusting throughput guidance for future sessions.

Another embodiment is directed to an apparatus including at least one apparatus and at least one memory including computer program code. The at least one memory and the computer program code are configured, with the at least one processor, to cause the apparatus at least to receive application content during a session, and to periodically generate and send acknowledgment (ACK) packet(s) to an application server providing the application content. In one embodiment, the at least one memory and the computer program code are further configured, with the at least one processor, to cause the apparatus at least to generate QoS/QoE information reports and to send the generated reports to the application server. In an embodiment, the QoS/QoE information reports may include what the UE has learned about available bandwidth, signal strength, application signal strength, etc. According to one embodiment, the at least one memory and the computer program code are further configured, with the at least one processor, to cause the apparatus at least to terminate the session and to send a summary QoE report to the application server.

Another embodiment is directed to a method including, during application content delivery to a UE associated with a network, monitoring and/or collecting instantaneous radio information from a network node (e.g., eNodeB) and computing at least cell load and throughput for the network. In an embodiment, the method may also include sending the collected radio information, cell load, and throughput information to the application server that is delivering content to the UE. For example, the information may be sent to the application server as part of TCP by enriching the TCP header information.

The method may further include receiving a UE specific QoE report, for example as part of TCP header extension message. In an embodiment, the method may then include extracting the QoE information and forwarding the application traffic to the UE. The method may also include receiving a QoE summary report and session summary from the application server, for example upon session termination (e.g., at time of TCP FIN). In one embodiment, the method may also include processing the QoE summary and session summary to provide additional insight for time series analysis, such as adjusting throughput guidance for future sessions.

Another embodiment is directed to a method including receiving application content during a session, and periodically generating and sending acknowledgment (ACK) packet(s) to an application server providing the application content. In one embodiment, the method may further include generating QoS/QoE information reports and sending the generated reports to the application server. In an embodiment, the QoS/QoE information reports may include what the UE has learned about available bandwidth, signal strength, application signal strength, etc. According to one embodiment, the method may also include terminating the session and sending a summary QoE report to the application server.

### BRIEF DESCRIPTION OF THE DRAWINGS

For proper understanding of the invention, reference should be made to the accompanying drawings, wherein:

FIG. 1 illustrates a block diagram of an example system architecture, according to one embodiment;

FIG. 2 illustrates an example of a QoE feedback trace, according to an embodiment;

FIG. 3 illustrates an example of a signalling diagram depicting the message sequence for a network configuration procedure, according to an embodiment;

FIG. 4 illustrates an example signalling diagram depicting a message sequence for deriving application insights, according to an embodiment;

FIG. 5a illustrates a block diagram of an apparatus, according to an embodiment;

FIG. 5b illustrates a block diagram of an apparatus, according to another embodiment;

FIG. 6a illustrates a flow diagram of a method, according to an embodiment; and

FIG. 6b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for cooperative application and network insight operations in wireless networks, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Embodiments of the invention provide a solution where application services can be improved by combining information from various sources. Operator and network equipment vendors like to see how well application services are working. However, there is no easy way to obtain insight on how applications and networks are working together to provide satisfactory Quality of Experience (QoE) to end users.

Currently, network operators may have several probes next to each network element and have also started to invest in probes for each application service. There are tools for voice over LTE (VoLTE), video analyzer, etc.; however, each of these tools does not proactively provide necessary network and applications insights. Rather, they just serve as reporting tools. These tools are expensive and become obsolete when ASPs change their delivery techniques.

Additionally, even if the application service is using the network or user information provided by network elements of mobile networks by any means to improve its service, the operator still needs to have external probes to ensure that the application service is working seamlessly and to verify any achieved improvement.

While ASPs have been attempting to improve their delivery mechanism, client application(s), etc., any modifications may make the current tools that are providing monitoring and measuring become obsolete. It also becomes more complicated for the operator, when ASPs turn ON their encrypted sessions, thereby rendering 3^{rd} party probes and tools as largely meaningless.

Currently, there is no existing mechanism wherein both the ASP and network operator can together have insight on the services consumed by users towards QoE.

In view of the above, embodiments of the invention avoid the usage of probes for each application analysis and provide a standard way for communicating network and application insight for future service enablement. Embodiments enable the network operator to know the ASP's application usage behavior on their network, and how the user is experiencing the ASP's services. In addition, embodiments provide a standardized API mechanism for the tools vendor, which will enable them to analyze even the encrypted sessions. It should be noted that embodiments are not restricted to any particular application or video service and therefore can be applied to any current or future application service.

Application servers generally do not have knowledge about networks and their conditions. Hence, insights from the application alone will not be successful in improving the user's QoE. On the other hand, deploying more probes and measuring the traffic pattern in the wireless network will not provide application usage insights.

It should be noted that an operator is not able to predict or realize the user and application servers' impact for a given underlying network. Due to this gap, user experience is impacted. As outlined above, operators and ASPs currently collect statistical information independently and there is no coordination or correlation as no sharing of such information occurs. Therefore, there are certain problems that continue to persist.

With respect to application insights for networks, operators may deploy probes and collect statistics, but they do not have knowledge about how the applications are using the network. For example, for video services that demands both bandwidth and latency, it is hard to understand how the application works under given network conditions, and what are the minimum network conditions that must be made available for the application. The lack of such information from the application to the network results in the operator not being able to provide necessary network conditions and may result in poor user experience. Adding probes for each application is not scalable and may be too expensive. Also, application servers and clients may change the delivery, message format, and streaming strategy. It is difficult for tools vendor to catch-up with such changes.

With respect to network Insights for applications, the application may assume that the network is capable of providing self-adjustment. However, radio network and packet core in 3G and LTE are different and difficult to place probes, and coordinate for each flow. Such lack of infrastructure may lead to incorrect assumptions, which in turn can lead to a bad user experience. Time varying bandwidth measurement is not easy, and even if the information is given to the application, the network should know how the application consumes the network insight in order to take continuous action by the network. Without such feedback, it is not going to be useful to derive meaning from the network insights.

With respect to the encrypted sessions mentioned above, ASPs are moving away from plain text session to these encrypted sessions. This essentially makes the middle box probes meaningless. This trend is going to continue and there is no existing solution to fill the gap and ensure that user sessions are well understood both by the network and application service provider.

As a result, at least the following problems/issues are addressed and overcome by embodiments of the present invention:
ASPs have started to migrate their services from plain text traffic to encrypted secure socket layer (SSL) traffic. There is currently no way to know what type of application traffic is being used for proper dimensioning
Operator(s) deploy middle box services to monitor, collect and learn the traffic behavior. Most of the traffic management solutions do some analytics based on network conditions and user experience. These will not work due to encrypted traffic.
Even for un-encrypted ASP traffic (e.g., YouTube™), ASPs constantly change their message structure, protocol semantics, buffering strategies, etc. (e.g., at least once a month). All the existing traffic management and monitoring companies do not get these changes and their results are often useless for the operator to improve their network performance.
Operators want to dimension the network, and want to understand various factors including average UE radio network occupancy time for dimensioning Those become difficult and also not possible with such middle box.
Mutual interest from application service provider and operator to understand the user behavior and improve the network and application streaming strategies.

It should be noted that the problems/issues noted above are some examples of the existing problems that may be overcome by embodiments of the invention. Of course, embodiments may also equally address other problems or issues that are not noted herein.

In an embodiment, the issues noted above are addressed by combing information from various parts of networks and applications, for example, over the internet. For example, in order to have application friendly networks, embodiments are configured such that both application and network insights are made available to each other, and made available instantly. Along with that, meaningful action may be taken based on the received information.

In order to improve user experience, numerous pieces of information need to be obtained, combined, and analyzed. Until now, applications and networks are served by different providers, with a result that users are often impacted with poor experience.

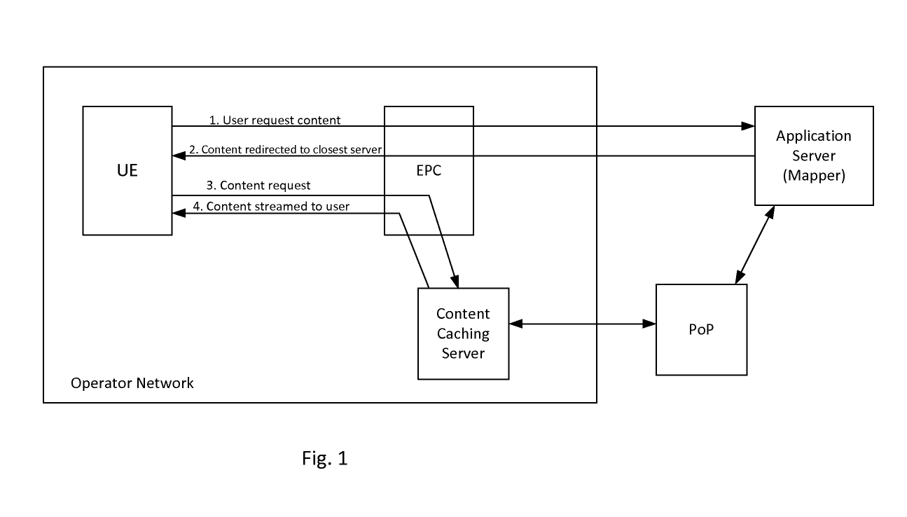

FIG. 1 illustrates a block diagram of an example content delivery architecture in which an embodiment of the invention may be applied. As illustrated in FIG. 1, the mapper server may be configured to receive, resolve and redirect user request(s) to the closest application content caching server (CCS). The CCS are servers with a public or private IP address. They may be deployed inside an operator premise, but managed and maintained by the ASP. Only list of IP address(es) that are needed to operate such servers are provided by the operator and the remainder is managed by the ASP. The content to CCS is populated via Point-Of-Presence (POP) servers. CCS are typically a few hops away from the EPC network but still inside the operator network.

A problem that exists today is that during a video streaming sessions data is sent in a burst, and there is a lot of variation in the radio network where these bursts may get lost or queued up in the network resulting in buffer under run which leads to disturbed video continuity. To solve this problem, embodiments are able to learn the network as well as the delivery. In addition, after the delivery, network needs to know the reason for any failure and the adaptations done by applications periodically to smoothen the failure.

In one embodiment, application servers are able to learn the radio change conditions. For example, the edge computing platform may receive instantaneous radio information from an eNodeB, to compute cell load, throughput guidance, etc. All these pieces of information can be communicated to the CCS server as part of transport control protocol (TCP) by enriching the header information, for example. In this manner, the ASP concerns may be addressed.

From the operator's perspective, the operator needs to know what is happening at the micro-level for application server traffic so that they can take corrective action when user experience degradation occurs. An operator likes to see the correlation of benefit for applications and users, and also want to use that information to improve other services. In an embodiment, the network operator needs to know if the variation is due to weather or network load or user location or improper dimensioning, etc.

According to one embodiment, for each identified user session, the edge computing platform may supply radio related information along with supplementary information that may be needed to improve user experience of the video traffic. An application running on a user device typically sends periodic feedback about the perceived quality level, and, in an embodiment, this feedback is reported directly back to the CCS.

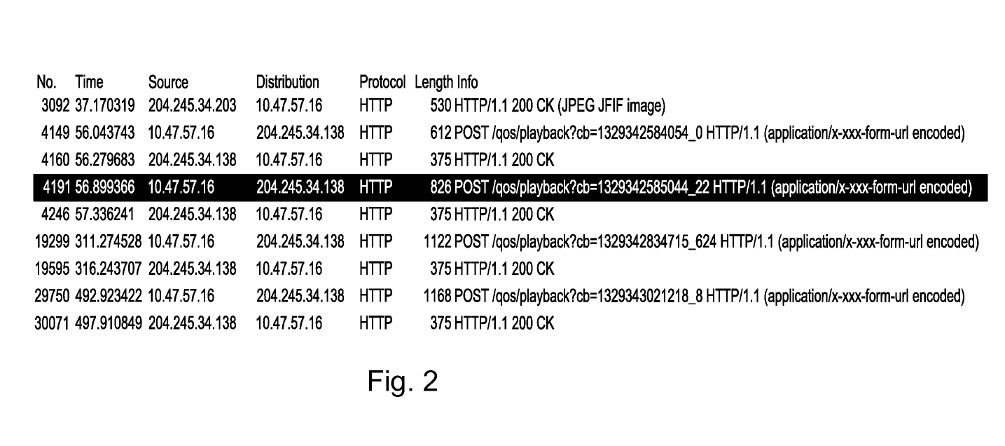

FIG. 2 illustrates an example of a QoE feedback trace from a UE towards the server (e.g., CCS). CCS may then learn and adjust the video stream to improve QoE. CCS may echo the same instantaneous information back to the edge computing platform, and CCS may also send summary information to the edge computing platform when the session is completed. The edge computing platform may use this information internally to summarize the same to the operator management infrastructure. The edge computing platform may also use this information to adjust the throughput guidance for future sessions.

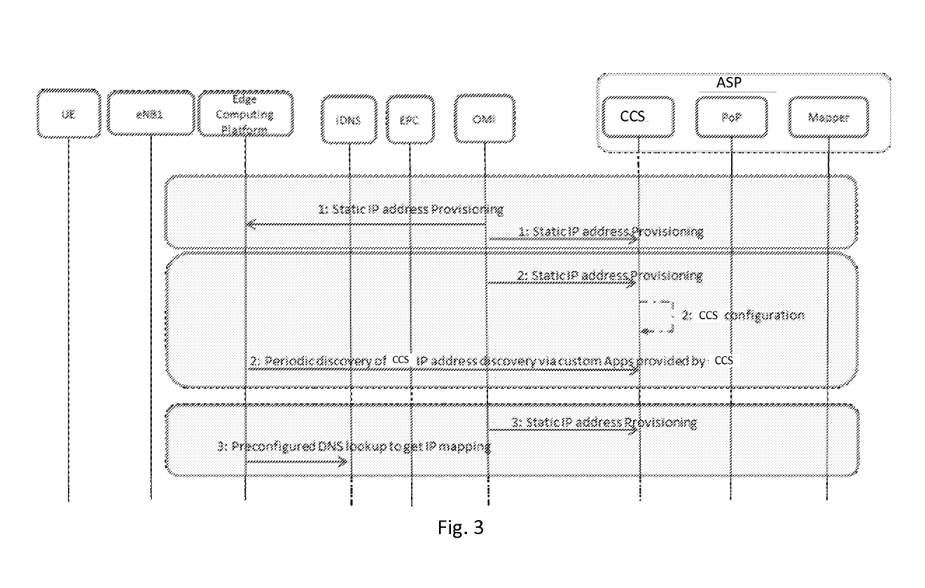

FIG. 3 illustrates an example of a signalling diagram depicting the message sequence for a network configuration procedure, according to one embodiment. Three possible steps to configure and bootstrap the systems include:
1. Operator (e.g., Operator-Management-Interface (OMI)) configures list of IP address(es) of CCS endpoints in both Edge Computing Platform and CCS servers.
2. Operator (e.g., OMI) supplies list of IP address to CCS endpoints and ASP configures servers accordingly. Edge Computing Platform implements a service discovery protocol to obtain the CCS endpoint IP address periodically, for example, using Rest/HTTP or any web interface provided by CCS.
3. Operator configures the internal domain name server (iDNS) with specific uniform resource locator (URL) name that is supplied by CCS vendor, the Edge Computing Platform learns URL name during system start-up, and performs a look up to resolve the IP address. (It is noted that Edge Computing Platform may be part of base transceiver station (BTS), or can be in path between BTS and the Core Network).

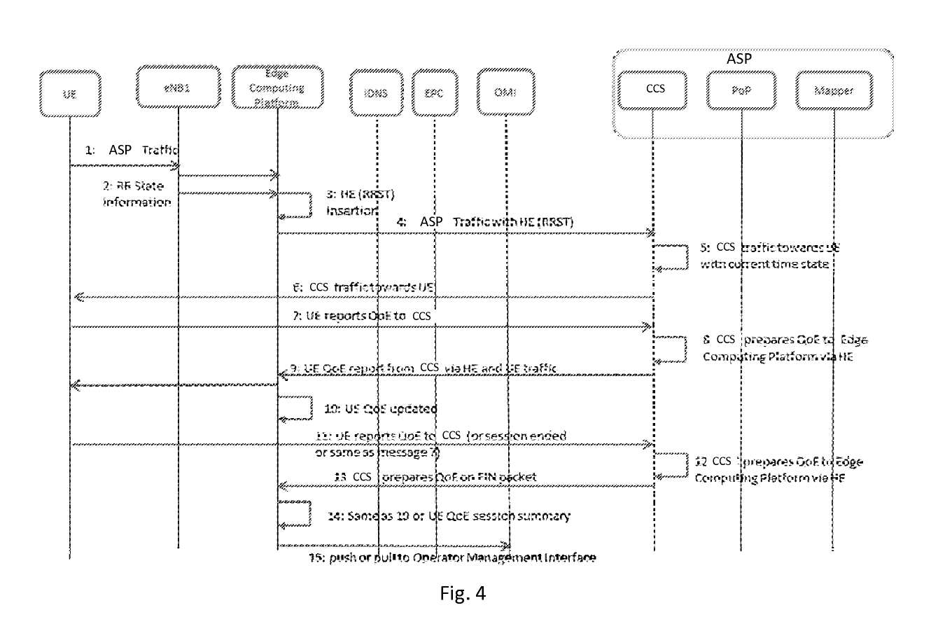

FIG. 4 illustrates an example signalling diagram depicting a message sequence for deriving application insights, according to an embodiment. For instance, FIG. 4 demonstrates how the network, application, and user statistics are collected and combined for both encrypted and plain text session, according to one example. Steps 1 to 4 may be part of Edge Computing Platform HE implementation. FIG. 1 discussed above depicts the interaction between CCS, application server, and client (e.g., UE). In FIG. 4, the message interaction that occurs between messages 3 and 4 of FIG. 1 is described. In this embodiment, the content is being delivered by CCS server to client and client has received the content.

As illustrated in FIG. 4, at 1, as the content (e.g., video content) is delivered over TCP, ACK will be generated periodically from the client (UE) towards the server. This ACK packet reaches the eNodeB and is received at Edge Computing Platform. At 2, the Edge Computing Platform internally monitors and collects several radio information and has both summarized and instantaneous information. At 3, the Edge Computing Platform enriches TCP header extensions with the radio information for the identified ASP traffic. Then, at 4, the Edge Computing Platform forwards the ASP traffic after HE processing towards the Application server. (Note: there are several possible ways to communicate this information as part of IPv4 or IPv6 or TCP to Application server. Those can be worked out with operator and ASP. The concept is that the information is delivered, and consumed by ASP).

In other embodiments, the Edge Computing Platform sends the load and insight to both UE and the CCS. For example, if two users are communicating via group video chat or normal point-to-point video chat, then the Edge Computing Platform may send the load and insight to both UE and the CCS server. Depending upon the type of application that is being monitored, Edge computing platform can send the network insight either in uplink direction or downlink direction or both.

Continuing with FIG. 4, at 5, in order to achieve satisfactory quality levels for given network conditions, the Application server internally process the HE information and performs necessary adjustment to streaming or other parameters. (Note: This step may be ASP dependent: some vendors change streaming strategy, some vendors do TCP congestion window changes, some do pacing, etc). At 6, the user and network receive and see the adapted traffic from Application server. Then, at 7, the UE may periodically prepare various reports (e.g., including its learning on available bandwidth, signal strength, application specific quality level and various other networks). These reports may be provided to the Application server, and the details of such a trace are illustrates in FIG. 2 as discussed above.

At 8, the Application server may prepare a UE specific QoE report, along with server generated reports to send to the Edge Computing Platform. This information may be communicated to the Edge Computing Platform as part of TCP Header extension message, for example. It is noted that there are several possible ways to communicate this information as part of IPv4 or IPv6 or TCP to CCS. It is also possible to run an IPv6 ICMP message and exchange over that. As the mobile network will become fully IPv6 in the near future, as an example this could be sent at IPv6 layer information by manipulating and reserving flow label information specific messages. At this stage, there are various choices and options possible for this implementation.

At 9, the Edge Computing Platform may receive the QoE report, extract QoE information, and forwards the actual application traffic towards the UE. Then, at 10, the Edge Computing Platform may collect the instantaneous and summary learning of QoE reports from the Application, and update the QoE information. At 11, the UE may terminate a session (or session is terminated by server) either normally or abnormally, and the UE may report the QoE toward the Application server.

Then, at 12, CCS server may prepare a QoE summary report and, at 13, the CCS may send the QoE summary report at the time of TCP FIN or other suitable IP or ICMP header extension mechanism (Note: In one embodiment, it is proposed to follow the same Edge computing Platform HE extension proposal from Edge Computing Platform to CCS so that consistency is maintained in implementation). At 14, the Edge Computing Platform may process the QoE summary, session summary and provide more insight for time series analysis or other appropriate machine learning techniques. Finally, at 15, the information contained for each micro-flow of user session is made available to Operator-Management-Interface (OMI) for further analysis or for other purposes, such as corrective action if there is a poor QoE or provide coverage or capacity extension or discount billing or declare that their network is congestion free in case of good quality experience etc.

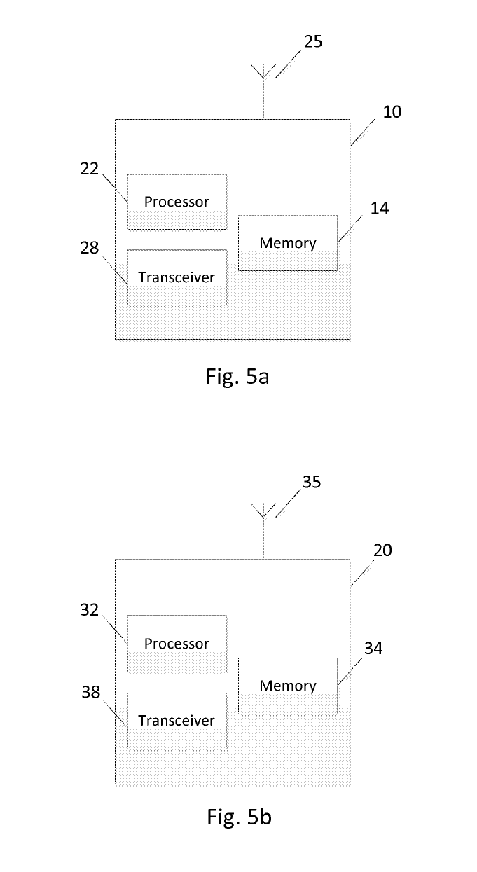

FIG. 5a illustrates an example of an apparatus 10 according to an embodiment. In an embodiment, apparatus 10 may be a node, host, or server in a communications network or serving such a network. It should be noted that one of ordinary skill in the art would understand that apparatus 10 may include components or features not shown in FIG. 5a.

As illustrated in FIG. 5a, apparatus 10 includes a processor 22 for processing information and executing instructions or operations. Processor 22 may be any type of general or specific purpose processor. While a single processor 22 is shown in FIG. 5a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a server, such as an edge computing server. In this embodiment, apparatus 10 may be controlled by memory 14 and processor 22, during application content delivery to a UE associated with a network, to monitor/collect instantaneous radio information from a network node (e.g., eNodeB) and to compute at least cell load and throughput for the network. In an embodiment, apparatus 10 may be further controlled by memory 14 and processor 22 to send the collected radio information, cell load, and throughput information to the application server that is delivering content to the UE. For example, apparatus 10 may send the information to the application server as part of TCP by enriching the TCP header information. In an embodiment, apparatus 10 may be further controlled by memory 14 and processor 22 to receive a UE specific QoE report, for example as part of TCP header extension message, to extract the QoE information, and to forward the application traffic to the UE.

According to an embodiment, apparatus 10 may be further controlled by memory 14 and processor 22 to receive a QoE summary report and session summary from the application server, for example upon session termination (e.g., at time of TCP FIN). In one embodiment, apparatus 10 may be further controlled by memory 14 and processor 22 to process the QoE summary and session summary to provide additional insight for time series analysis, such as adjusting throughput guidance for future sessions.

FIG. 5b illustrates an example of an apparatus 20 according to an embodiment. In an embodiment, apparatus 20 may be a node, host, or server in a communications network or serving such a network. In one embodiment, apparatus 20 may be a UE, mobile device, or other user device. It should be noted that one of ordinary skill in the art would understand that apparatus 20 may include components or features not shown in FIG. 5b.

As illustrated in FIG. 5b, apparatus 20 may include a processor 32 for processing information and executing instructions or operations. Processor 32 may be any type of general or specific purpose processor. While a single processor 32 is shown in FIG. 5b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further comprise or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also comprise or be coupled to one or more antennas 35 for transmitting and receiving signals and/or data to and from apparatus 20. Apparatus 20 may further comprise or be coupled to a transceiver 38 configured to transmit and receive information. The transceiver may be an external device, such as a remote radio head. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a UE which may, for example, be associated with or in communication with a network. In this embodiment, apparatus 20 may be controlled by memory 34 and processor 32 to receive application content during a session, and to periodically generate and send acknowledgment (ACK) packet(s) to an application server providing the application content. In one embodiment, apparatus 20 may be further controlled by memory 34 and processor 32 to generate QoS/QoE information reports and to send the generated reports to the application server. In an embodiment, the QoS/QoE information reports may include what the UE has learned about available bandwidth, signal strength, application signal strength, etc. According to one embodiment, apparatus 20 may also be controlled by memory 34 and processor 32 to terminate the session and to send a summary QoE report to the application server.

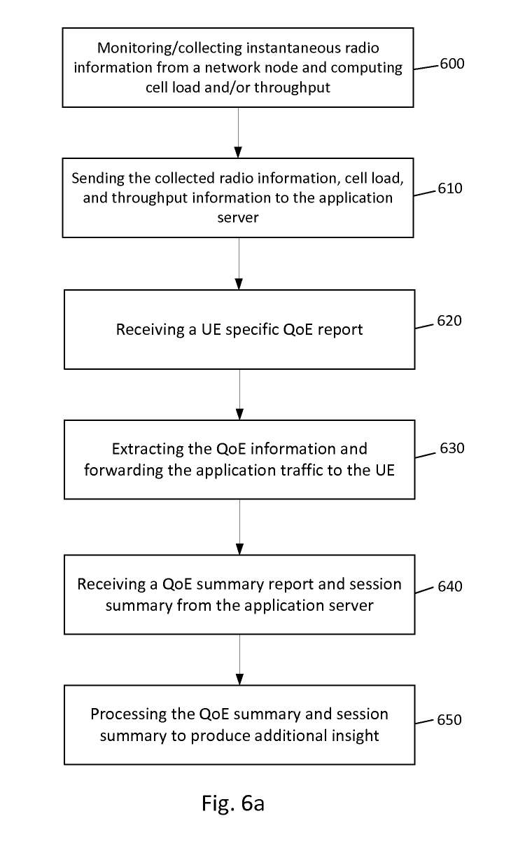

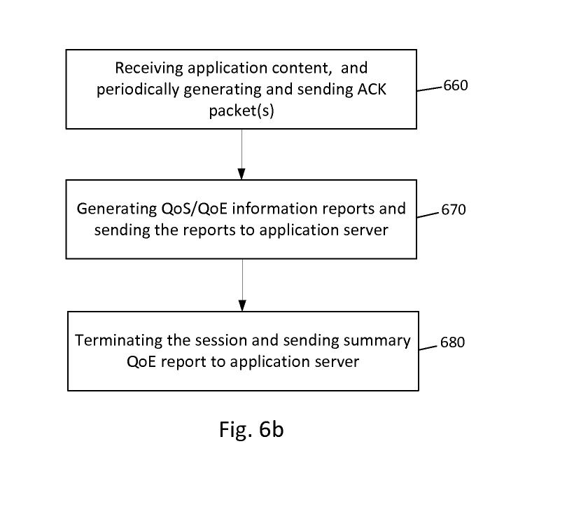

FIG. 6a illustrates a flow diagram of a method according to one embodiment of the invention. In one embodiment, the method may include, at 600, during application content delivery to a UE associated with a network, monitoring and/or collecting instantaneous radio information from a network node (e.g., eNodeB) and computing at least cell load and throughput for the network. In an embodiment, the method may also include, at 610, sending the collected radio information, cell load, and throughput information to the application server that is delivering content to the UE. For example, the information may be sent to the application server as part of TCP by enriching the TCP header information.

Continuing with FIG. 6a, the method may further include, at 620, receiving a UE specific QoE report, for example as part of TCP header extension message. In an embodiment, the method may then include, at 630, extracting the QoE information from the received QoE report and forwarding the application traffic to the UE. The method may also include, at 640, receiving a QoE summary report and session summary from the application server, for example upon session termination (e.g., at time of TCP FIN). In one embodiment, the method may include, at 650, processing the QoE summary and session summary to produce additional insight for time series analysis, such as adjusting throughput guidance for future sessions.

FIG. 6b illustrates a flow diagram of a method according to another embodiment of the invention. In one embodiment, the method may include, at 660, receiving application content during a session, and periodically generating and sending acknowledgment (ACK) packet(s) to an application server providing the application content. In one embodiment, the method may further include, at 670, generating QoS/QoE information reports and sending the generated reports to the application server. In an embodiment, the QoS/QoE information reports may include what the UE has learned about available bandwidth, signal strength, application signal strength, etc. According to one embodiment, the method may also include, at 680, terminating the session and sending a summary QoE report to the application server.

In some embodiments, the functionality of any of the methods described herein, such as that of FIGS. 6a and 6b, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The mutual exchange of information, as provided according to embodiments of the invention described above, helps both the network operator and the application server provider to scale up the service independently. Some advantages according to embodiments of the invention include, but are not limited to, providing a mechanism where the operator can learn and understand the radio network, core network, application server impact on encrypted SSL session. Additionally, embodiments provide instantaneous QoE values for each application session; values that are derived are readily available, and easy to integrate for billing, future planning, and troubleshooting purposes. The concept of a probe-less architecture is a key requirement for Telco cloud, and embodiments can provide tight integration for the operator, application service provider and network vendor based on the probe-less architecture. It should be noted that embodiments are reusable to other vendors and services, as well as interoperable with existing operator network infrastructure services.

As a result of the exchanging and combing of network information and application behavior information for secured session, operators can improve network performance and efficiency. Joint application and network coordinated delivery and analysis helps achieve the notion of probe-less architectures and relieves from service guarantee. Operator can use data generated by embodiments of the invention for dimensioning the network based on usage and application experience directly. In addition, operators can utilize the data for supplementary functions, such as providing discounts in cases where user experience is not up to standards. Ultimately, because application vendors and operators are able to work closely to improve user experience according to embodiments of the invention, user experience can be improved.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus, comprising:
at least one processor; and
at least one memory including computer program code,
the at least one memory and the computer program code configured, with the at least one processor, to cause the apparatus at least to
during application content delivery to a user equipment associated with a network, monitor and/or collect instantaneous radio information from a network node and compute at least cell load and throughput for the network;
send the collected radio information, cell load, and throughput information to an application server that is delivering content to the user equipment.

2. The apparatus according to claim 1, wherein the at least one memory and the computer program code are further configured, with the at least one processor, to cause the apparatus at least to receive a user equipment specific quality of experience (QoE) report, to extract the quality of experience (QoE) information, and to forward the application traffic to the user equipment (UE).

3. The apparatus according to claim 1, wherein the at least one memory and the computer program code are further configured, with the at least one processor, to cause the apparatus at least to receive a quality of experience (QoE) summary report and session summary from the application server upon session termination.

4. The apparatus according to claim 1, wherein the at least one memory and the computer program code are further configured, with the at least one processor, to cause the apparatus at least to process the quality of experience (QoE) summary and session summary to provide additional insight for time series analysis including adjusting throughput guidance for future sessions.

5. A method, comprising:
during application content delivery to a user equipment (UE) associated with a network, monitoring and/or collecting instantaneous radio information from a network node and computing at least cell load and throughput for the network; and
sending the collected radio information, cell load, and throughput information to an application server that is delivering content to the user equipment (UE).

6. The method according to claim 5, further comprising:
receiving a user equipment specific quality of experience (QoE) report;
extracting the quality of experience (QoE) information; and
forwarding the application traffic to the user equipment (UE).

7. The method according to claim 5, further comprising receiving a quality of experience (QoE) summary report and session summary from the application server upon session termination.

8. The method according to claim 5, further comprising processing the quality of experience (QoE) summary and session summary to provide additional insight for time series analysis including adjusting throughput guidance for future sessions.

9. A computer program, embodied on a non-transitory computer readable medium, the computer program configured to control a processor to perform a method according to any one of claims 5-8.

10. An apparatus, comprising:
at least one processor; and
at least one memory including computer program code,
the at least one memory and the computer program code configured, with the at least one processor, to cause the apparatus at least to
receive application content during a session;
periodically generate and send acknowledgment (ACK) packets to an application server providing the application content; and
generate quality of service (QoS)/quality of experience (QoE) information reports and to send the generated reports to the application server.

11. The apparatus according to claim 9, wherein the quality of service (QoS)/quality of experience (QoE) information reports comprise information on what the user equipment (UE) has learned about available bandwidth, signal strength, and/or application signal strength.

12. The apparatus according to claim 9, wherein the at least one memory and the computer program code are further configured, with the at least one processor, to cause the apparatus at least to terminate the session and to send a summary QoE report to the application server.

13. A method, comprising:
receiving application content during a session;
periodically generating and sending acknowledgment (ACK) packets to an application server providing the application content;
generating quality of service (QoS)/quality of experience (QoE) information reports; and
sending the generated reports to the application server.

14. The method according to claim 13, wherein the quality of service (QoS)/quality of experience (QoE) information reports comprise information on what the user equipment (UE) has learned about available bandwidth, signal strength, and/or application signal strength.

15. The method according to claim 13, further comprising terminating the session and sending a summary QoE report to the application server.

16. A computer program, embodied on a non-transitory computer readable medium, the computer program configured to control a processor to perform a method according to any one of claims 13-15.
